(19) United States
(12) Patent Application Publication
(10) Pub. No.: US 2012/0158655 A1
(43) Pub. Date: Jun. 21, 2012

(54) NON-RELATIONAL FUNCTION-BASED DATA PUBLICATION FOR RELATIONAL DATA

(75) Inventors: Bryan Dove, Seattle, WA (US); Michael J. Bortnick, Oswego, IL (US); Stuart M. Bowers, Redmond, WA (US); Robert L.C. Parker, Chevy Chase, MD (US)

(73) Assignee: Microsoft Corporation, Redmond, WA (US)

(21) Appl. No.: 12/972,530

(22) Filed: Dec. 20, 2010

(51) Int. Cl. G06F 17/30

(52) U.S. Cl. 707/627; 707/E17.005

(57) ABSTRACT

A data publication system is described herein that provides a data replication model that combines benefits of data distribution from non-relational paradigms with the benefits of deeply integrating datasets via relational database paradigms. The system allows the creation of programmatic functions for extracting subsets of data stored in any source model, extracting data from a variety of sources, and republishing that data in a target model built upon the aggregated source data. The target model can provide standard relational paradigms across a set of data from multiple sources, whether or not the original sources were relational in nature. The system applies known paradigms for data replication based upon programmatic functions as a means for data replication and integrates this method for data duplication and replication based upon arbitrary functions with the power of relational database systems to process associated entities of data in highly efficient ways.

### BACKGROUND

A relational database is a collection of related data. Relationships can include tuples having the same attributes, such as a table where each row is a tuple that has attributes stored in columns, and can include relationships among tables, such as a table that lists people by name that is related to another table of purchases made by the people. Relational databases typically define a strict schema in the form of the columns in tables, the column data types, and the relationships between tables expressed in queries, views, and other operators for accessing data. The organization of data is often a design choice that affects how the data can be accessed as well as performance of various types of uses of the databases. Data in a database can include many types of content, including numbers, text, binary data, images, web links, and so forth. Relational databases today contain a vast amount of data, some of which is shared via the Internet or the ability to purchase a copy of an entire database.

Data replication refers to the concept of copying database data, usually for maintaining consistency between multiple copies of the data. For example, a service with guaranteed up time often replicates databases to several servers so that if one server fails, server processes can access the data from another server. At any given time, a database server may be providing services to external consumers while also replicating the result of each modification request to one or more replicas. Replication is often transactional, meaning that databases attempt to maintain ACID properties (atomicity, consistency, isolation, and durability) so that the original and replicated data is in a known state at all times and operations are processed reliably.

Relational databases are inherently limited to operating on data as a single set, whether expressed physically or logically as a single set of data. Non-relational data structures suffer at performing complex intersection, filtering, or aggregate computations at scale. The vast amounts of data available today are often useful for performing a limited purpose that does not involve an entire dataset from a source. Relational databases are not generally well suited to replicating a small subset of data rather than the entire relational model and dataset. Often the strict structure that makes relational databases great at quickly performing complex operations becomes a hindrance for extracting focused subsets of data for purposes other than that for which the database was designed. Many current areas of computer science leverage existing data in new ways. For example, the effort to unify patient health information often involves bringing together data from a wide variety of sources to provide a service to doctors or patients based on the data. This type of service is not easy with current database technology.

### SUMMARY

A data publication system is described herein that provides a data replication model that combines benefits of data distribution from non-relational paradigms with the benefits of deeply integrating datasets via relational database paradigms. The system allows the creation of programmatic functions for extracting subsets of data stored in any source model, extracting data from a variety of sources, and republishing that data in a target model built upon the aggregated source data. The target model can provide standard relational paradigms across a set of data from multiple sources, whether or not the original sources were relational in nature. The system applies known paradigms for data replication based upon programmatic functions as a means for data replication. The system integrates this method for data duplication and replication based upon arbitrary functions with the power of relational database systems to process associated entities of data in highly efficient ways. The data replication paradigm works from raw source data, applies the programmatic function, and delivers the data to one or more destinations. In this model, the destinations of these functions are entities that exist in one or more relational database instances that exist in one or more environments. Thus, the data publication system brings the power of the relational database model to large problems for which the model traditionally would not scale well.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the data publication system, in one embodiment.

FIG. 2 is a flow diagram that illustrates processing of the data publication system to gather and combine data from a variety of data sources for publication as a unified dataset, in one embodiment.

FIG. 3 is a flow diagram that illustrates processing of the data publication system to publish aggregated combined, non-relational dataset to one or more relational database instances, in one embodiment.

FIG. 4 is a dataflow diagram that illustrates a flow of data from various potentially non-relational data sources to one or more relational target database instances, in one embodiment.

### DETAILED DESCRIPTION

A data publication system is described herein that provides a data replication model that combines benefits of data distribution from non-relational paradigms with the benefits of deeply integrating datasets via relational database paradigms. The system allows the creation of programmatic functions for extracting subsets of data stored in any source model, extracting data from a variety of sources, and republishing that data in a target model built upon the aggregated source data. The target model can provide standard relational paradigms across a set of data from multiple sources, whether or not the original sources were relational in nature. The system applies known paradigms for data replication based upon programmatic functions (e.g., MapReduce-style paradigms) as a means for data replication. The system integrates this method for data duplication and replication based upon arbitrary functions with the power of relational database systems to process associated entities of data in highly efficient ways. The data replication paradigm works from raw source data, applies the programmatic function, and delivers the data to one or more destinations. In this model, the destinations of these functions are entities that exist in one or more relational database instances that exist in one or more environments.

The data publication system provides a number of improvements over existing database technology. The system introduces programmatic function data distribution as a means of relational database replication, manipulating the output of MapReduce functions via relational database structures, integration of non-relational data structures with multiple relational database engines to create a cohesive solution, and techniques to scale relational database instances within a single logical instance to thousands or millions of instances. As raw data is brought into a logical instance of the system, the raw data is delivered to an arbitrary array of data stores that can exist on one or more physical computing nodes. This data is then mapped via a series of inferred data structures, semantics, and source, as well as explicitly identified metadata about the data's origin. The union of all sources' respective metadata is holistically represented as the data catalog of the system's dataset. The system then expresses an outcome for a particular use of the data as a relational database (logical database schema) in terms of, or mapped to, the system's data catalog.

Once an individual relational database target is defined, the programmatic functions to replicate the data from the system's source dataset are generated to deliver the data to the target relational database instance in near real-time. This replaces traditional database replication techniques that are driven as methods to copy data already expressed in a relational data structure. The experience of consuming this data for clients is similar to accessing a current day relational database system. The ability to programmatically describe the language of data distribution, and have a paradigm that is proven to scale to thousands and millions of target destinations does not exist today in relational databases. Thus, the data publication system brings the power of the relational database model to large problems for which the model traditionally would not scale well.

Once data is in a relational form it is typically difficult or impossible to move the data by any method other than a copy of the relational structure as a whole to a new location. By gathering and publishing data in a non-relational form, replicating the gathered data to a variety of destinations still in non-relational form, and then imposing a relational structure at the final destination, the system provides the client with all of the abilities of the relational model, but does not impose the restrictions of the relational model on the distribution phase of managing data.

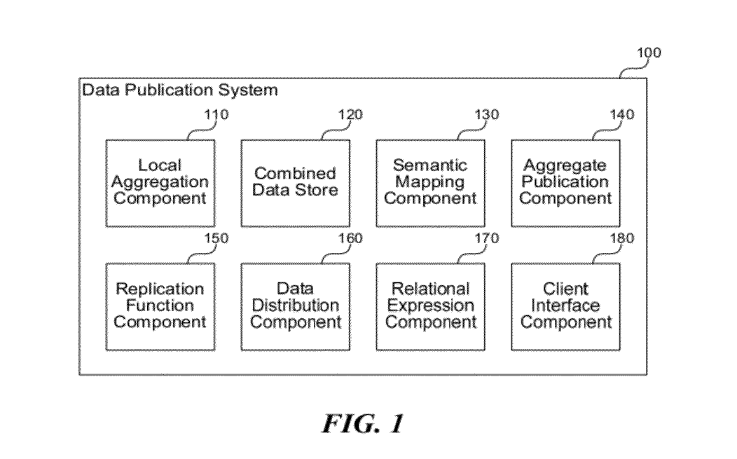

FIG. 1 is a block diagram that illustrates components of the data publication system, in one embodiment. The system 100 includes a local aggregation component 110, a combined data store 120, a semantic mapping component 130, an aggregate publication component 140, a replication function component 150, a data distribution component 160, a relational expression component 170, and a client interface component 180. Each of these components is described in further detail herein.

The local aggregation component 110 retrieves data from one or more data sources and collects the data in the combined data store 120. The data sources may include various relational or non-relational database sources as well as non-database sources of data, including web pages, news feeds, web services, and so forth. The system gathers data from disparate sources and collects the data into a central location that can be mined for a particular purpose, such as supporting an application that leverages the combined data. The component 110 may retrieve the data using a variety of protocols and transports, such as using common protocols (e.g., transmission control protocol (TCP) at a low level and Structured Query Language (SQL) at a high level) over the Internet to collect data stored in sources at various locations.

The combined data store 120 stores data gathered from the data sources for publication by the aggregate publication component 140. The data store 120 may include one or more in-memory data structures, files, file systems, hard drives, external storage devices, storage area networks (SANs), databases, cloud-based storage services, or other facilities for persistently storing data. The combined data store 120 holds data in raw form until the semantic mapping component 130 infers semantic information and structures the data for publications.

The semantic mapping component 130 determines semantic information about data gathered from the data sources. For example, the system may determine semantic information by automated analysis of the data that infers relationships and other semantic information by inspecting the data. The system may allow users or administrators to manually tag data and may perform automatic semantic recognition to tag and classify gathered data. The determined semantic information allows the system to project the data as a unified dataset published by the aggregate publication component 140. After semantic mapping, regardless of the data's original source the system can publish the data as a unified dataset, or subsets of the data requested by a particular application. The semantic mapping component 130 may execute one or more delegate functions to produce intermediate data in a format expected by an application.

The aggregate publication component 140 publishes gathered data in accordance with the determined semantic information to one or more data destinations. The aggregate publication component 140 does not impose any relational model on the data and the data may be as structured or unstructured as the original data suggests. The determination of semantic information may identify relationships or other organizational qualities of the data that the aggregate publication component 140 can expose to data consumers. The union of all sources' respective metadata is holistically represented as the data catalog of the system's dataset.

The replication function component 150 generates one or more functions for replicating a portion of the published data originally from the data sources to one or more relational database instances. The functions replicate the data from the system's source dataset to deliver the data to the target relational database instance in near real-time. The functions may interpret non-relational data published by the aggregate publication component 140 in accordance with a relational schema defined for the target database instance. Relational databases are typically replicated from identical relational database instances. The replication function component 150 allows data to be replicated in a scalable way from non-relational sources by the application of dynamically generated functions that resemble a MapReduce model for gathering data from a variety of sources and combining that data into a relational paradigm at the target.

The data distribution component 160 distributes data published by the aggregate publication component to one or more target relational database instances by applying the generated functions for replicating data. The functions may mold the data into a variety of different relational models to allow replicating one set of source data gathered from various raw sources to various target relational database instances. The target instances may support a variety of types of client applications that typically access relational data. The data distribution component 160 allows such applications to be fed data from a variety of non-traditional, non-relational sources efficiently.

The relational expression component 170 expresses the distributed data as a relational model at the one or more target relational database instances. The relational expression component 170 may receive user input that defines a particular relational model expected by a client application or particular design of the user. The user may provide a schema or other information that identifies the types of data and format of the data that a particular target database instance expects to receive. The data distribution component 170 helps to support the relational model by converting and replicating non-relational data in a manner that conforms to the particular relational target instances. This provides a powerful data distribution paradigm through which multiple relational database instances can be fed data at high scale from a variety of sources.

The client interface component 180 provides an interface to client applications that access relational data from the one or more target relational database instances. Using the data publication system 100, clients remain largely unchanged and can access data in a familiar relational model that they are accustomed to today, even though the particular relational database instance is receiving data through a non-traditional, non-relational distribution model.

The computing device on which the data publication system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

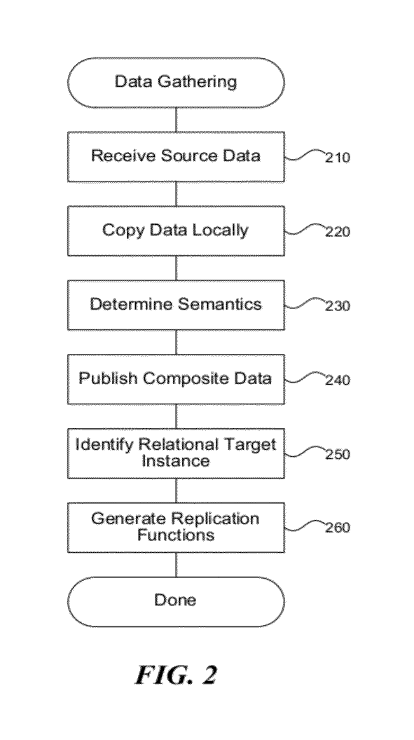

FIG. 2 is a flow diagram that illustrates processing of the data publication system to gather and combine data from a variety of data sources for publication as a unified dataset, in one embodiment. Beginning in block 210, the system receives source data from one or more data sources. The data sources may include many sources of data in many different formats. The system gathers the source data and stores it in an arbitrary array of data stores that can exist on one or more physical computing nodes that represent a logical instance of the system.

Continuing in block 220, the system copies the data locally to a combined data store. The combined data store may be distributed across multiple physical servers. Once the data is brought local, the system can publish the data as a unified dataset from a single system instance, regardless of the original source, format, or type of the data. The source data may include relational and non-relational sources as well as non-database sources.

Continuing in block 230, the system determines semantic information about the received source data. The semantic information may include automated recognition of semantic information and manual tagging by users to create semantic data tags. The system may also infer or capture source information about the data as well as other properties of the data, and relationships between data from different sources. The system maps the data via one or more inferred data structures, semantics, sources, and explicitly identified metadata to produce a unified, holistic data catalog.

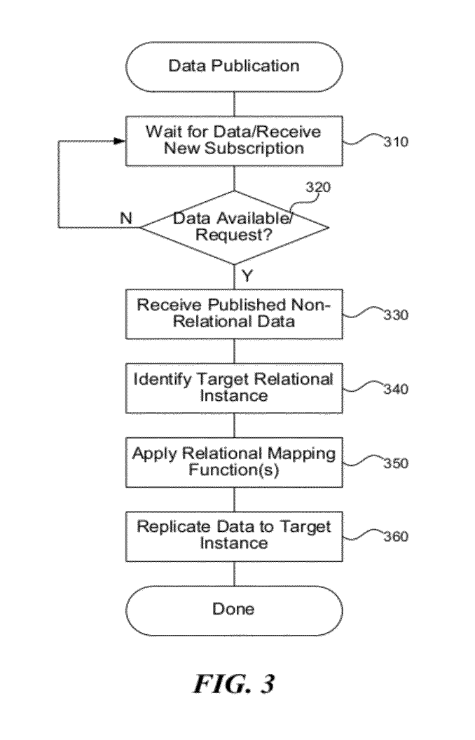

Continuing in block 240, the system publishes the received composite data combined from multiple data sources along with determined semantic information to one or more data consumers. The system publishes the data in a non-relational format that can be replicated to relational database instances by one or more replication functions. The published data feeds a data distribution component, described further with reference to FIG. 3, which converts and distributes the non-relational data to one or more target relational database instances.

Continuing in block 250, the system identifies a target relational database instance to which to publish composite non-relational data. For example, data targets may register with the system or an administrator may setup the system to distribute data to a specified list of target instances. The target instances may represent conventional relational database systems to which the data publication system flexibly publishes non-relational data combined from a variety of sources.

Continuing in block 260, the system generates one or more replication functions that convert data from a non-relational source format to a target relational database format associated with the identified target relational database instance. For example, the function may place the data into a schema expected by the target instance, including a particular row and column format for tabular data. The system uses the mapping of source data published by the system to determine differences between the source format and target format and to determine appropriate actions for converting and replicating the source data to the target instance. After block 260, these steps conclude.

FIG. 3 is a flow diagram that illustrates processing of the data publication system to publish aggregated combined, non-relational dataset to one or more relational database instances, in one embodiment. In some embodiments, the process of FIG. 3 follows that of FIG. 2 to periodically replicate newly arriving data to one or more target database instances.

Beginning in block 310, the system waits for new non-relational source data to arrive for replication to one or more relational database target instances. For example, the system may receive notification when new data arrives or periodically check for new data from the data publication component of the system. The system may also receive a request from a new subscriber for which it can gather previously captured and/or new data to satisfy the request. The system periodically gathers or receives data from a variety of raw data sources and combines the data into a unified, mapped data catalog. The processes of waiting for new data to arrive as well as processing already captured data on demand of a new subscription work together to deliver functionality of the system. Continuing in decision block 320, if the system determines that data is available, then the system continues at block 330, else the system loops to block 310 to continue waiting for new data.

Continuing in block 330, the system receives published non-relational data aggregated by the system from one or more distributed data sources. The system may locally gather source data and store the data in a data catalog along with inferred semantics and semantic data tags. The system may receive new data as the sources change or may periodically check sources to determine whether new data is available. Upon finding new data, the system gathers the data to local physical nodes, catalogs the data, and publishes it for distribution to one or more target instances.

Continuing in block 340, the system identifies a relational database target instance. The instance may be located remotely and used to support a particular client application or other purpose. The target instance relies on data provided from the data catalog of the system, and may not be aware of the original source or format of the data. To the target instance, the data may appear to be conventional replicated relational data, even though the sources are non-relational in nature.

Continuing in block 350, the system applies one or more relational mapping functions that distribute the aggregated non-relational data to the identified relational database target instance. The mapping functions provide a flexible and scalable replication service for conveying non-relational source data to multiple relational database instances. The system may automatically generate the mapping functions based on source and target data schemas or may receive manual user intervention to help create functions to carry out the data distribution.

Continuing in block 360, the system replicates the mapped data to the identified relational database target instance. The system may communicate with the target instance using common networking and/or database protocols for replicating data between databases. The system may appear to the target instance as a relational database copy of the target instance that provides transactional updates to the target instance. This manner of publishing data allows client applications to access data from a well-understood relational model while data distribution occurs using more efficient, non-relational means of replication. After block 360, the system loops to block 310 to wait for more data to replicate.

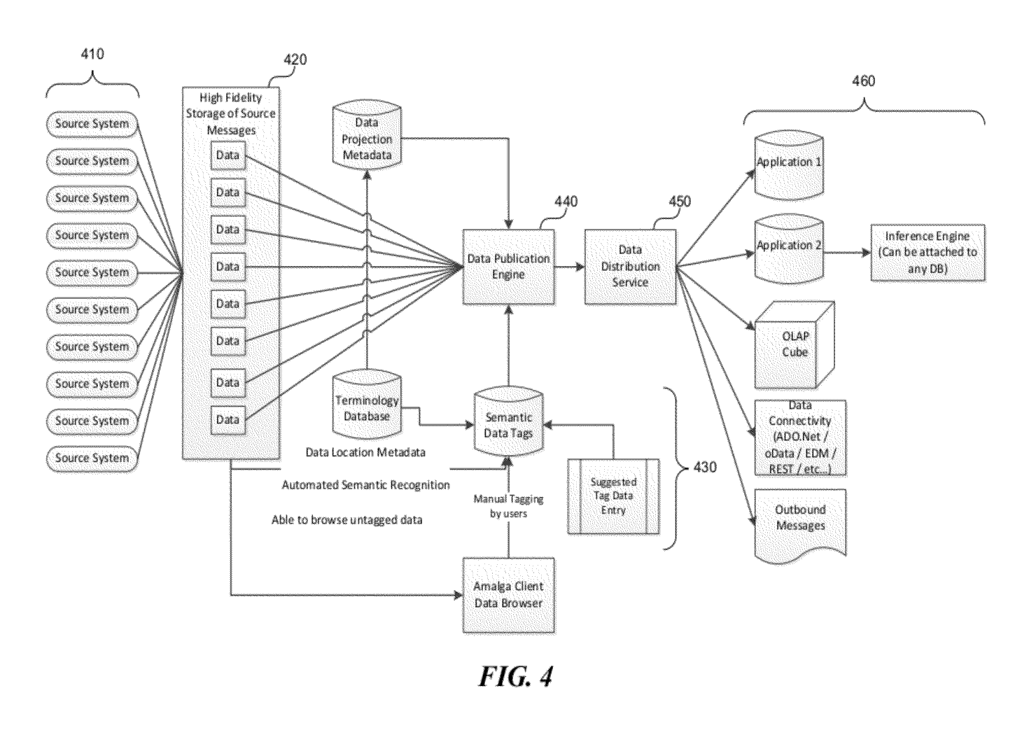

FIG. 4 is a dataflow diagram that illustrates a flow of data from various potentially non-relational data sources to one or more relational target database instances, in one embodiment. The system gathers data from potentially many source systems 410. The data may be stored by the source systems 410 in a variety of formats, and the source systems may include any type of data source, including currently existing publicly available databases. The system next gathers the source data locally for storage in a high-fidelity store 420. The store 420 provides a uniform place for the system to collect and manipulate the data. The stored data undergoes tagging and semantic analysis 430, which may include automated semantic recognition, gathering data source metadata, and manual data tagging by users.

The gathered and analyzed data then feeds the data publication engine 440, which exposes the data as a unified data catalog. At this point, the data is semi-structured, non-relational data from a variety of sources brought into a common location. The data then flows to the data distribution service 450, which uses one or more generated mapping functions to express the gathered data in a relational model and replicate the data to a variety of data consumers 460. The consumers 460 may include one or more client applications, programmatic application-programming interfaces (APIs), and so forth.

The techniques described herein enable a wealth of possibilities for handling data. Because the function can use a different mapping function for each destination, the destinations do not need to be determined a priori as in traditional replication. New targets can be added over time and they can select subsets of the published data catalog to receive. For example, a data catalog of car information may replicate only engine-related component information to one target. The system can also perform semantic based filtering. For example, the Center for Disease Control (CDC) may want to receive lab test information, but have personal information stripped away before replication to preserve privacy. The system can have multiple inputs and multiple outputs, with the inputs being filtered and organized in a variety of ways to ultimately provide the target instances with subsets of the data catalog in a familiar form for the target instance.

In some embodiments, the data publication system provides an enhanced query experience over traditional models. As an example, assume that a particular application wants to identify only medical patients taking COX 2 inhibitors. The application may not actually know which drugs that includes, but can use the system to avoid needing to determine that information. For example, the application runs a delegate function that queries public data to find particular drugs that are COX 2 inhibitors, then the system publishes the information to the application in the form that the application wants. The intervening functions between the source data and target allow a variety of types of intermediate processing to provide data to the target in a format that may not actually exist at any particular source, but can be assembled from all of the sources.

In some embodiments, the data publication system provides sophisticated online analytical processing (OLAP). The system can quickly adapt to changing sources or changing subscription demands on the fly, whereas OLAP is typically rigid in its schema and resistant to change over time without updating the schema. For example, if an application wants information about cars driven by patients taking COX 2 inhibitors, the system can gather this data from separate data sources identifying car owners and drugs taken by particular patients. The system can then analyze and correlate this data through semantic analysis and particular mapping functions to achieve the result sought by the application. The system can then publish the data for the application to use in a traditional relational model, so that the application can perform any specific analysis with that subset of data.

In some embodiments, the data publication system can receive mapping specifications for mapping data from a source schema to a target schema in a variety of formats. For example, the system can receive extensible markup language (XML), resource description framework (RDF), JavaScript Object Notation (JSON), Common Schema Definition Language (CSDL), or other descriptions of sets of attributes to gather from the source data and provide to the target database instances.

In some embodiments, the data publication system is highly scalable. There are no node limits, the system can receive data from multiple sources and provide that data to multiple destinations with no single point that creates a bottleneck. Individual nodes of the system can process data from particular sources or for particular destinations without interfering or waiting for other nodes. The system can also instantiate new types of relationships, go back to historical data, and reapply analysis to pull old data into new models of understanding that data. Thus, the value of the system and ability to expand over time are virtually unlimited. Consumers are abstracted from the layout of sources, so the system can be used in an expanding variety of ways. Sources can be heterogeneous. The system integrates semantics, abstracting the physical storage format of the database from application expectations of semantics. The subscribers also need not be computer savvy, and can declaratively specify needs and auto-execute available delegate functions to make a desired result happen (e.g., NoSQL).

From the foregoing, it will be appreciated that specific embodiments of the data publication system have been described herein for purposes of illustration, but that various modifications may be made without deviating from the spirit and scope of the invention. Accordingly, the invention is not limited except as by the appended claims.

I/We claim:

1. A computer-implemented method for gathering and aggregating data from a variety of heterogeneous data sources for publication as a unified dataset, the method comprising:
receiving source data from one or more data sources;
copying the data locally to a combined data store;
determining semantic information related to the received source data;
publishing the received data aggregated from multiple data sources along with determined semantic information to one or more data consumers;
identifying a target relational database instance to which to publish aggregated non-relational data; and
generating one or more replication functions that convert data from a non-relational source format to a target relational database format associated with the identified target relational database instance,
wherein the preceding steps are performed by at least one processor.

2. The method of claim 1 wherein receiving source data comprises receiving non-relational source data from publicly accessible data sources.

3. The method of claim 1 wherein receiving source data comprises gathering the source data and storing it in an arbitrary array of data stores that can exist on one or more physical computing nodes that represent a logical instance of a data publication system.

4. The method of claim 1 wherein copying the data locally comprises copying the data to a combined data store distributed across multiple physical servers.

5. The method of claim 1 wherein copying the data locally comprises exposing the data as a unified dataset from a single system instance, regardless of the original source, format, or type of the data.

6. The method of claim 1 wherein determining semantic information comprises performing automated recognition of semantic information in the received source data.

7. The method of claim 1 wherein determining semantic information comprises receiving manual data tagging information from one or more users to create semantic data tags.

8. The method of claim 1 wherein determining semantic information comprises inferring information from the source data.

9. The method of claim 1 wherein determining semantic information comprises mapping the data via one or more inferred data structures, semantics, sources, and explicitly identified metadata to produce a unified, holistic data catalog.

10. The method of claim 1 wherein publishing the received data comprises publishing the data in a non-relational format that can be replicated to relational database instances by one or more replication functions.

11. The method of claim 1 wherein identifying the target instance comprises receiving registration from a target instance to receive updates to an identified subset of data.

12. The method of claim 1 wherein generating replication functions comprises generating a function that places the data into a schema expected by the target instance using the determined semantic information.

13. A computer system for Non-Relational Function-Based Data Publication for Relational Data, the system comprising:
a processor and memory configured to execute software instructions embodied within the following components;
a local aggregation component that retrieves data from one or more data sources and collects the data in a combined data store;
a combined data store that stores data gathered from the data sources for publication by an aggregate publication component;
a semantic mapping component that determines semantic information about data gathered from the data sources;
an aggregate publication component that publishes gathered data in accordance with the determined semantic information to one or more data destinations;
a replication function component that generates one or more functions for replicating a portion of the published data originally from the data sources to one or more relational database instances; and
a data distribution component that distributes data published by the aggregate publication component to one or more target relational database instances by applying the generated functions for replicating data.

14. The system of claim 13 wherein the local aggregation component retrieves data from sources that include multiple relational or non-relational database sources as well as non-database sources of data.

15. The system of claim 13 wherein the semantic mapping component determines semantic information by automated analysis of the data that infers relationships and other semantic information by inspecting the data.

16. The system of claim 13 wherein the semantic mapping component executes one or more delegate functions to produce intermediate data in a format expected by an application.

17. The system of claim 13 wherein the aggregate publication component does not impose any relational model on the data and provides a union of all sources' respective data as a holistic data catalog.

18. The system of claim 13 wherein the replication function component produces one or more functions that replicate the data from the system's source dataset to deliver the data to the target relational database instance in near real-time.

19. The system of claim 13 wherein the replication function component allows data to be replicated in a scalable way from non-relational sources by the application of dynamically generated functions for gathering data from a variety of sources and by combining that data into a relational paradigm at the target database instances.

20. A computer-readable storage medium comprising instructions for controlling a computer system to publish an aggregated, non-relational dataset to one or more relational database instances, wherein the instructions, upon execution, cause a processor to perform actions comprising:
waiting for new non-relational source data to arrive for replication to one or more relational database target instances;
receiving published non-relational data aggregated from one or more distributed data sources;
identifying a relational database target instance located remotely that supports a particular client application and that relies on data provided from the data catalog of the system without known an original source or format of the data;
applying one or more relational mapping functions that distribute the aggregated non-relational data to the identified relational database target instance; and
replicating the mapped data to the identified relational database target instance.
